(19) United States
(12) Patent Application Publication
(10) Pub. No.: US 2022/0036304 A1
(43) Pub. Date: Feb. 3, 2022

(54) COMPUTER METHODS AND SYSTEMS FOR IDENTIFYING PARTS AND INVENTORY

(71) Applicant: Honeywell International Inc., Morris Plains, NJ (US)

(72) Inventors: Chris ROBERSON, Peoria, AZ (US); Susan BARLOW, Chandler, AZ (US)

(21) Appl. No.: 16/945,348

(22) Filed: Jul. 31, 2020

(51) Int. Cl. G06Q 10/08; G06F 16/2455; G06Q 50/04; G06Q 10/10; G06Q 10/06; G06F 16/28

(52) U.S. Cl. CPC G06Q 10/0875; G06F 16/24565; G06F 16/288; G06Q 10/10; G06Q 10/06315; G06Q 50/04

(57) ABSTRACT

Disclosed are methods, systems, and non-transitory computer-readable medium for identifying missing parts and stranded inventory. For instance, the method may include: obtaining parts data and work in progress (WIP) data associated with one or more production facilities, the parts data indicating one or more parts in an inventory to be used to produce one or more products, the WIP data indicating one or more WIP products currently in production; analyzing the parts data and the WIP data to determine missing parts and/or on-hand parts for the one or more WIP products; and performing at least one action for the missing parts and/or the on-hand parts.

### TECHNICAL FIELD

Various embodiments of the present disclosure relate generally to methods and system for identifying parts and, more particularly, to methods and system for identifying missing parts and stranded inventory.

### BACKGROUND

Generally, businesses may have a misalignment of materials (e.g., parts) for products to be produced. For instance, in a large organization there may be millions of records for specific materials being used to produce any number of particular products. Some of those materials may not be aligned correctly (e.g., misaligned with a product or not on-hand when needed/requested so as to proceed with the production of the product). A challenge may be determining which parts are not aligned correctly for which products that are currently in production. Moreover, another challenge may determining which, of any parts identified as being misaligned, are worth obtaining so as to ensure production of products.

The present disclosure is directed to overcoming one or more of these above-referenced challenges.

### SUMMARY OF THE DISCLOSURE

According to certain aspects of the disclosure, systems and methods are disclosed for methods and system for identifying missing parts and stranded inventory.

For instance, a method may include: obtaining parts data and work in progress (WIP) data associated with one or more production facilities, the parts data indicating one or more parts in an inventory to be used to produce one or more products, the WIP data indicating one or more WIP products currently in production; analyzing the parts data and the WIP data to determine missing parts and/or on-hand parts for the one or more WIP products; and performing at least one action for the missing parts and/or the on-hand parts.

A system may include a memory storing instructions; and a processor executing the instructions to perform a process. The process may include: obtaining parts data and work in progress (WIP) data associated with one or more production facilities, the parts data indicating one or more parts in an inventory to be used to produce one or more products, the WIP data indicating one or more WIP products currently in production; analyzing the parts data and the WIP data to determine missing parts and/or on-hand parts for the one or more WIP products; and performing at least one action for the missing parts and/or the on-hand parts.

A non-transitory computer-readable medium may store instructions that, when executed by a processor, cause the processor to perform a method. The method may include: obtaining parts data and work in progress (WIP) data associated with one or more production facilities, the parts data indicating one or more parts in an inventory to be used to produce one or more products, the WIP data indicating one or more WIP products currently in production; analyzing the parts data and the WIP data to determine missing parts and/or on-hand parts for the one or more WIP products; and performing at least one action for the missing parts and/or the on-hand parts.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system for identifying missing parts and stranded inventory, according to one or more embodiments.

FIG. 2 depicts a flowchart for identifying missing parts and stranded inventory, according to one or more embodiments.

FIG. 3 depicts a flowchart for identifying missing parts and stranded inventory, according to one or more embodiments.

FIG. 4 depicts an example system that may execute techniques presented herein.

### DETAILED DESCRIPTION OF EMBODIMENTS

Various embodiments of the present disclosure relate generally to methods and system for identifying parts.

In general, the present disclosure is directed to methods and system for identifying missing parts and stranded inventory. For instance, a system of the present disclosure may determine material is not aligned correctly (e.g., missing parts for products to be completed) and determines a shortage impact of the missing parts and/or stranded inventory of products to be completed. The shortage impact may be an expected value of the completed product divided amongst all of the missing parts for that product. The stranded inventory may be an expected value of the completed product less the cost of obtaining the missing parts. In this manner, a user may be informed of missing parts and their relative differences in value, so as to make an informed decision whether to chase down the missing parts.

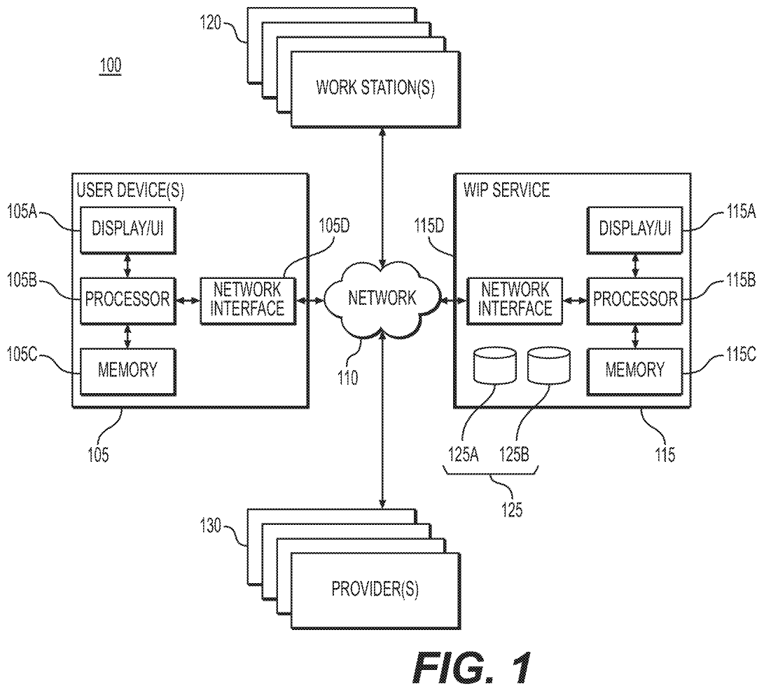

FIG. 1 depicts an exemplary block diagram of a system 100 for identifying missing parts and stranded inventory, according to one or more embodiments. The system 100 may include one or more user device(s) 105, a network 110, a work-in-progress (WIP) service 115, one or more workstation(s) 120, and/or one or more provider(s) 130. The one or more user device(s) 105, the WIP service 115, the one or more workstation(s) 120, and/or the one or more provider(s) 130 may be connected via the network 110, using one or more standard communication protocols. The network 110 may be one or a combination of the internet, a local network, wide-area network, or other network. The one or more user device(s) 105, the WIP service 115, the one or more workstation(s) 120, and/or the one or more provider(s) 130 may transmit and receive messages from each other across the network 110.

The one or more workstation(s) 120 (hereafter for ease of reference “workstation 120”) may be a computer, a cell phone, a tablet, etc. associated with one or more production facilities. The one or more production facilities may produce one or more products (e.g., physical and/or software products). The workstation 120 may store and execute a workstation program. The workstation 120 may be the user device 105, or it may be a different device.

The workstation program may, automatically and/or based on user inputs, track a state for each product being produced. The workstation program may receive system and/or user inputs indicating a product being produced (referred to as a WIP product) has been: (1) started being produced, (2) updated (e.g., by adding or removing a physical or software part to/from the WIP product), (3) ended (e.g., cancelled without being completed); and/or (4) completed (e.g., the WIP product is finished being produced). For instance, in the case of automated assembly of products (as a whole or only for portions thereof), associated devices of the automated assembly may track and confirm (e.g., image processing, sensors indicating a product has advanced to a certain position associated along an assembly line indicating certain parts have been added) assembly of the products; and transmit messages to the workstation 120 indicating, for each product being produced, the parts being added/removed, etc. for the product. In the case of non-automated assembly of products, a user may interact with a workstation interface to indicate the parts being added/removed, etc. for the product. The workstation program may update a state for each product as information is received for each product. The workstation program may then transmit an update product message to the WIP service 115 indicating changes to WIP products (e.g., new WIP product, add part to WIP product, remove part from WIP product, end WIP product, and/or WIP product complete). The workstation program may transmit the update product message as changes occur or at predetermined intervals as a batch of changes (e.g., once a day).

The workstation program may, automatically and/or based on user inputs, track an inventory of parts associated with the one or more production facilities. The workstation program may receive system and/or user inputs indicating a part has been added to or remove from the inventory. For instance, devices associated with the inventory may track and confirm (e.g., wireless tags on parts and wireless sensors, image processing to identify objects, etc.) parts being added to or removed from the inventory; and transmit messages to the workstation 120 indicating the parts being added to or removed from the inventory. A user may interact with the workstation interface to indicate the parts being added to or removed from the inventory. The workstation program may update an inventory database indicating additions to or removal from the inventory. The workstation program may then transmit an update parts message to the WIP service 115 indicating changes to the inventory database (e.g., part added to and/or part removed from). The workstation program may transmit the update parts message as changes occur or at predetermined intervals as a batch of changes (e.g., once a day).

Alternatively or additionally, the workstation program may track the state for each product being produced based on the changes to the inventory of parts. For instance, as each part is removed from or added to the inventor of parts, the workstation program may associate the removed/added part with a product, and update the state for the product based on the removed/added part. As an example, the workstation program may: as a part is removed from the inventory, receive a system/user input indicating a WIP product for the removed part; update the state for the WIP product to indicate the part is being added to the WIP product; as a part is added to the inventory, receive a system/user input indicating a new part or WIP product; and in response to the input indicating a product, update the state for the WIP product to indicate the part is being removed from the WIP product. In response to the input indicating a new part, the workstation program may not update the state for any WIP product, but instead only update the inventory database.

The workstation program may receive instruction messages from the WIP service 115. The workstation program may display the instruction message in the workstation interface. The instruction message may include information indicating one or more on-hand parts, as discussed below. The user of the workstation 120 may use the information indicating the one or more on-hand parts to produce/complete WIP products.

The one or more provider(s) 130 (hereafter for ease of reference “provider 130”) may be a computer, a cell phone, a tablet, etc. associated with one or more suppliers of parts. Some (or none) of the one or more provider(s) 130 may be a different division of a same entity that produces the products at the one or more production facilities that produce one or more products, and/or some (or none) of the one or more provider(s) 130 may be third party suppliers that are un-related to the entity that produces the products at the one or more production facilities. In either case, the provider 130 may receive part request messages from the user device 105, the WIP service 115, and/or the workstation 120 requesting a part (physical or software). For instance, the provider 130 may accept requests in accordance with an API to automatically receive and confirm requests. The provider 130 may notify an associated user of the provider 130 that the part has been requested, and the user and/or the provider 130 may cause the part to be transmitted (e.g., shipped or digitally transmitted) to the workstation 120, the one or more production facilities, or an agreed upon location.

Each of the one or more user device(s) 105 (hereafter “user device 105” for ease of reference) may include a display/UI 105A, a processor 105B, a memory 105C, and/or a network interface 105D. The user device 105 may be a computer, a cell phone, a tablet, etc. The user device 105 may execute, by the processor 1058, an operating system (O/S) and at least one application (each stored in memory 105C). The application may be a desktop application, a browser program, or a mobile application program (which may also be a browser program in a mobile O/S). The application may generate one or more graphic user interfaces (GUIs) based on instructions/information stored in the memory 105C, and/or instructions/information received from the WIP service 115. The GUIs may, for instance, be application UIs for the application executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the network 110. The processor 1058, while executing the application, may receive user inputs from the display/UI 105A, and perform actions or functions in accordance with the application.

The application may allow a user to interact with the WIP service 115 to request and/or receive reports. For instance, the application may generate and display an application interface (e.g., an application GUI on a mobile device, a webpage for web site/web application on a browser). The application may: receive user inputs on the application interface to request a report; transmit a request message to the WIP service 115 (e.g., in response receiving the user input or automatically in response to opening the application); receive a response from the WIP service 115 with a report; and update the application interface to display the report. Additionally or alternatively, the application may receive the report from the WIP service 115 without transmitting the request message, e.g., so that the application may display the report in the application interface in response to a user opening the application on the user device 105.

The WIP service 115 may include a display/UI 115A, a processor 115B, a memory 115C, and/or a network interface 115D. The WIP service 115 may be a computer, system of computers (e.g., rack server(s)), or a cloud service computer system. The WIP service 115 may execute, by the processor 1156, an operating system (O/S) and at least one instance of a WIP program (each stored in memory 115C). The WIP service 115 may store or have access to WIP information 125. The display/UI 115A may be a touch screen or a display with other input systems (e.g., mouse, keyboard, etc.) for an operator of the WIP service 115 to control the functions of the WIP service 115 (e.g., update the WIP program and/or the WIP information). The network interface 115D may be a TCP/IP network interface for, e.g., Ethernet or wireless communications with the network 110.

The WIP information 125 may include WIP data 125A and parts data 125B. The WIP data 125A may include all WIP products in the one or more production facilities and states for the WIP products. For instance, particular workstations 120 may only store WIP products for the production facility associated with the particular workstations 120. The parts data 125B may include an inventory of all parts present in the one or more production facilities and/or parts scheduled to be present in the one or more production facilities in association with delivery dates. The delivery dates may include a calendar date and/or time on which the parts are scheduled to be present in the one or more production facilities. For instance, particular workstations 120 may only track inventory for the production facility associated with the particular workstations 120. Therefore, the WIP information 125 may track all WIP products (and their states) and the inventory of all of the production facilities. One of skill in the art would recognize that individual production facilities may be considered separate from the remainder, e.g., by filtering or storing the data separately.

The parts data 125B may include a part ID for each part used in the products produced in the production facilities, a count for each part ID that corresponds to a number of the parts in the inventory for that part ID, location information for each part in the inventory, and/or expected cost for each part. The part ID may identify the type of part. The location information may indicate a production facility where the part is stored in inventory.

WIP products in the WIP data 125A may, for each WIP product, include an identifier (e.g., a unique ID to track the WIP product), a type identifier (e.g., to indicate a specific product type), an expected value of a completed WIP product, and/or a build-by date. The expected value of a completed WIP product may correspond to a sales price, etc. for the completed product. The build-by date may be a date the completed product is scheduled to be done production. The states in the WIP data 125A may be WIP data structures. The WIP data structures may include an identifier (corresponding to the identifier of the WIP product, so that the state may be matched to the WIP product) and an indication of one or more parts already assembled for the WIP product. The indication of one or more parts already assembled for the WIP product may be: (1) a list of the parts (e.g., by part ID, such as a bill of material for a product); (2) a reference index; and/or (3) a part-assembly pairing. The reference index may indicate a stage in assemble, and the stage may indicate all parts going forward that are required to complete production of the WIP product. The part-assembly pairing may include all parts needed to complete the WIP product and, for each of all of the parts needed to complete the WIP product, an indicator. The indicator may be true or false (0 or 1, etc.) indicating a part has been added to the WIP product (true) or the part has not been added to the WIP product (false).

The WIP data 125A may also include relationship models for the WIP products. The relationship models may include assembly lists, interface lists, connection lists, and any other additional lists describing the relationships of all of the products produced at the one or more production facilities. The relationship models may also include type identifiers corresponding to the products produced at the one or more facilities. The assembly lists may include, for example, lists of the parts needed to assemble the WIP product. The interface lists may include lists of connectors between the parts of the assembly lists for the WIP products. The connection lists may include, for example, a list of attributes of the connections between the WIP products. The additional net lists may include, for example, lists of other connection arrangement information and/or spacing arrangement for the parts for the WIP products. The WIP server 115 may use the relationship models to determine dependencies between parts of WIP products (e.g., if a sub-assembly needs a part to finish the sub-assembly, the sub-assembly cannot be added to the WIP product). The dependencies may indicate an order of parts to finish producing a WIP product.

The WIP program may receive update product messages and/or update parts messages from the workstation 120; and update the WIP data 125A and/or the parts data 125B based on received update product messages and/or update parts messages.

The WIP program may: determine whether one or more trigger conditions are satisfied; in response to determining the one or more trigger conditions are not satisfied, return to determine whether the one or more trigger conditions are satisfied; and in response to determining whether the one or more trigger conditions are satisfied, execute an analysis process.

To determine whether one or more trigger conditions are satisfied, the WIP program may determine whether one or more of an update product message, update parts message, or a request have been received, and/or whether a default trigger condition has been satisfied. The default trigger condition may be an end to periodic timer (e.g., every day, or some other time period).

The WIP program may, while executing the analysis process: obtain the WIP data 125A and/or the parts data 125B; extract WIP products and states from the WIP data 125A; obtain relationship models for the WIP products; determine needed parts based on the relationship models and/the states for WIP products; and determine missing parts and/or on-hand parts based on needed parts and the parts data 125B.

To obtain the WIP data 125A and/or the parts data 125B, the WIP program may: access the WIP information 125; and extract the WIP data 125A and/or the parts data 125B. To extract the WIP products and the states from the WIP data 125A, the WIP program may: obtain the WIP data 125A; extract the states and WIP products; and associate states and WIP products based on identifiers of the states and WIP products. To obtain the relationship models for the WIP products, the WIP program may: obtain the relationship models; and select particular relationship models based on type identifiers of the WIP products that match type identifiers of relationship models.

To determine the needed parts based on the relationship models and/or the states for WIP products, the WIP program may: determine the parts required to complete the WIP product by: extracting the indication of one or more parts already assembled for the WIP product; and determining parts not included in the WIP product yet based on the indication of one or more parts already assembled for the WIP product. For instance, if the indication includes the list of the parts already included, the WIP program may reference the assembly lists of the relationship model for the WIP product to determine what has not yet been included. For instance, if the indication includes the reference index, the WIP program may access the stage in assemble to determine all parts going forward that are required to complete production of the WIP product. For instance, if the indication includes the part-assembly pairing, the WIP program may determine which parts have false indicator values.

To determine missing parts and/or on-hand parts based on needed parts and the parts data 125B, the WIP program may determine missing parts by finding matching part IDs in the parts data 125B that have a count equal to zero and/or by finding late scheduled parts. Finding late scheduled parts may include finding matching part IDS in the parts data 125B that have a count greater than zero and a delivery date after a build by date for a WIP product. The WIP program may determine on-hand parts by finding matching part IDs in the parts data 125B that have a count greater than zero and by finding on-time schedule parts. Finding on-time schedule parts may include finding matching part IDS in the parts data 125B that have a count greater than zero and a delivery date before (or more than a threshold more than before) a build by date for a WIP product.

Additionally or alternatively, the WIP program may also determine missing parts when a count for a matching part ID is less than a total of needed parts for the matching part ID. In this case, the WIP program may associate the missing parts with WIP products that have more (or less) missing parts; associate the missing parts randomly for the WIP products that need the matching part IDs; associate the missing parts with WIP products that have a deadline farther away in time than other WIP products; and/or associate the missing parts with WIP products that have a lower (or higher) expected value.

In one aspect of the disclosure, the analysis process may determine missing parts that have relatively high value as compared to other missing parts. Specifically, the WIP program may, while executing the analysis process: determine whether there is at least one missing part; in response to determining there is no missing part, return to determine whether the one or more trigger conditions are satisfied; in response to determining there is at least one missing part, determine value(s) of missing part(s) (e.g., “shortage impact” of missing parts); select particular missing part(s) based on value(s); and initiate a part request to provider 130 for particular part(s) and/or initiate a report to user device 105. As an example, when a part is not going to be available on time to the build-by date (e.g., is a missing part), the analysis program may determine that a WIP product that needs that part is an impacted build for a production order. Furthermore, the analysis program may, for each missing part of the impacted build (as there may be at least one missing part for each impacted build) determine a shortage impact, a revenue impact, and/or a stranded impact. Stranded impact may be equal to the value of all the parts on-hand that are allocated to build the impacted build. For instance, the analysis program may sum standard costs of on-hand parts allocated for the impacted build. Shortage impact may be equal to value of impacted build (the WIP product) divided by a count of the missing parts. Sales impact is equal to a sales value for the impacted build (the WIP product) divided by the count of the missing parts.

To determine the value(s) of the missing part(s), the WIP program may: extract the expected value of a completed WIP product for the WIP product associated with missing part; obtain a number of missing parts for the WIP product; divide the expected value by the number of missing parts for the WIP product to determine a value for the corresponding missing parts of the WIP product.

To select particular missing part(s) based on the value(s), the WIP program may use a ranking algorithm. The ranking algorithm may select a predetermined number of missing part(s) with a highest value; select missing part(s) with a value above a threshold (e.g., $20k); select missing part(s) associated with WIP products that have a deadline sooner than other missing part(s); select missing part(s) associated with WIP products that have a deadline less than a threshold away; select missing parts with WIP products that have more (or less) missing parts; select missing parts with WIP products that have more (or less) missing parts than a threshold; select missing parts with WIP products that have a lower (or higher) expected value; select missing parts with WIP products that have an expected value above a threshold; and/or select missing parts that has no dependencies or dependencies less than a threshold (e.g., based on the relationship model). Alternatively, the ranking algorithm may determine a score based on one or combinations of: a value of a missing part; a time to deadline for the WIP product of the missing part; a number of missing parts for the WIP product of the missing part; an expected value of the WIP product of the missing part; and/or a number of dependencies for the missing part(s).

To initiate a part request to provider 130 for particular part(s), the WIP program may: determine a provider 130 for one or more selected missing parts, generate the request message; and transmit the request message to the determined provider 130. To initiate the report to the user device 105, the WIP program may: generate the report and transmit the report. The report may include one or a combination of: values of missing part(s); time to deadlines for the WIP products of the missing part(s); a number of missing parts for the WIP products of the missing part(s); an expected value of the WIP products of the missing part(s); a number of dependencies for the missing part(s); and/or a stranded inventory indicator for each WIP product with missing parts. The stranded inventory indicator for each WIP product with missing parts may indicate a difference between the expected value of the WIP product less the total cost to obtain the missing parts.

The report may order the missing part(s) based on: decreasing order or value, increasing time to deadline, increasing number of missing parts for the WIP products of the missing part(s); decreasing expected value of the WIP products of the missing part(s); and/or increasing number of dependencies for the missing part(s). The report may also include a total value of WIP products that are delayed due to missing parts (by, e.g., summing missing parts). Therefore, a user of the user device 105 may be informed of what parts are worth tracking down from supplies.

In one aspect of the disclosure, the analysis process may determine on-hand parts that have relatively high value as compared to other on-hand parts. Specifically, the WIP program may, while executing the analysis process: determine value(s) of on-hand part(s); select particular on-hand part(s) based on value(s); and initiate an instruction message to the workstation 120.

To determine the value(s) of on-hand part(s), the WIP program may: extract the expected value of a completed WIP product for the WIP product associated with on-hand part; obtain a number of on-hand parts to complete the WIP product; divide the expected value by the number of on-hand parts for the WIP product to determine a value for the corresponding on-hand parts of the WIP product. To select particular on-hand part(s) based on the value(s), the WIP program may use the ranking algorithm, discussed above.

To initiate an instruction message to the workstation 120, the WIP program may: generate and transmit the instruction message. The instruction message may indicate the selected on-hand parts to a user, so that the user may select an on-hand part to complete an order based on expected value.

Therefore, the system of the present disclosure may determine material is not aligned correctly (e.g., missing parts for WIP products to be completed) and determines a shortage impact of the missing parts and/or stranded inventory of products to be completed. The shortage impact and/or stranded inventory may then be shared with users to help them determine whether to obtain the missing parts.

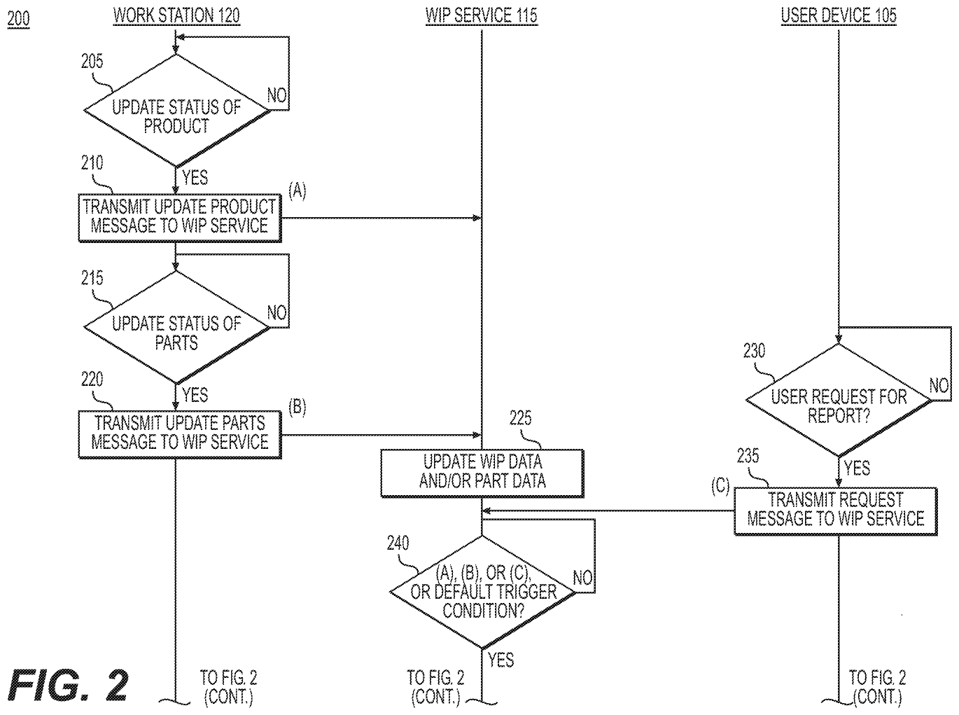

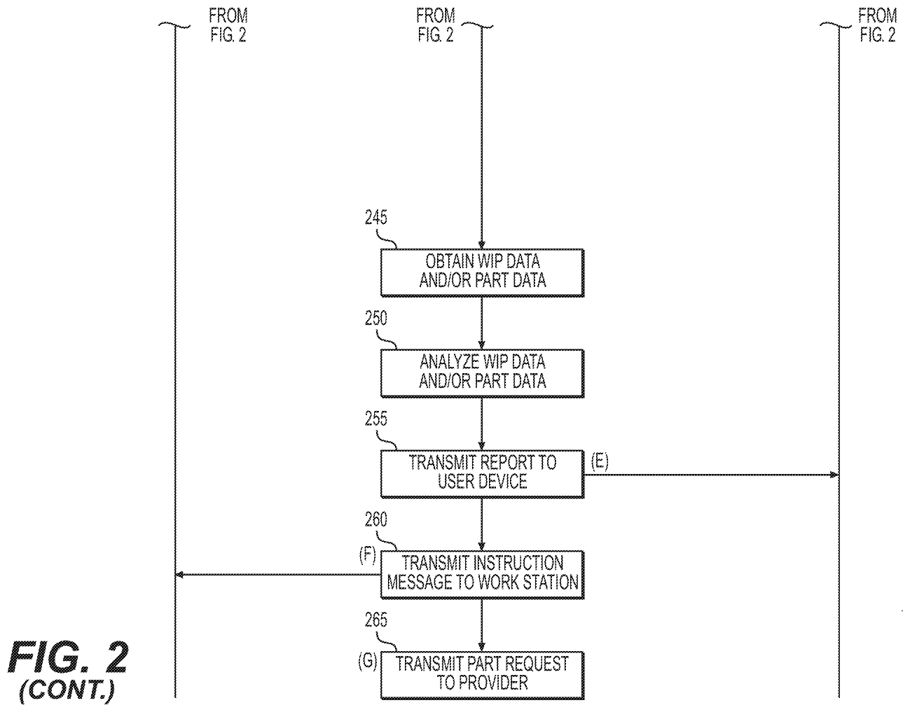

FIG. 2 depicts a flowchart 200 for identifying missing parts and stranded inventory, according to one or more embodiments. The flowchart 200 may depict the WIP process, discussed above. The WIP process of the flowchart 200 may be performed by the workstation 120, the WIP service 115, and the user device 105. The flowchart 200 of FIG. 2 may depict operations and flows of data represented by stages (A)-(G), which can be performed in the order shown or in a different order.

In stage (A), the workstation 120 may determine whether a status of a product has been updated (block 205). For instance, the workstation 120 may track a state for each product being produced, as discussed above with respect to FIG. 1. In response to determining a status of a product has been updated (block 205: Yes), the workstation 120 may transmit an update product message to the WIP service 115 (block 210). For instance, the workstation 120 may generate the update product message and transmit the update product message to the WIP service 115, as discussed above with respect to FIG. 1. In response to determining a status of a product has not been updated (block 205: No), the workstation 120 may return to determine whether a status of a product has been updated (block 205).

In stage (B), the workstation 120 may determine whether a status of parts has been updated (block 215). For instance, the workstation 120 may track the inventory of parts associated with the one or more production facilities, as discussed above with respect to FIG. 1. In response to determining a status of parts has been updated (block 215: Yes), the workstation 120 may transmit an update parts message to the WIP service 115 (block 220). For instance, the workstation 120 may generate the update parts message and transmit update parts message to the WIP service 115, as discussed above with respect to FIG. 1. In response to determining a status of parts has not been updated (block 215: No), the workstation 120 may return to determine whether a status of parts has been updated (block 215).

In stage (C), the user device 105 may determine whether a user requests a report (block 230). For instance, the user device 105 may receive a user input requesting a report, as discussed above with respect to FIG. 1. In response to determining the user requests the report (block 230: Yes), the user device 105 may transmit a request message to the WIP service 115 (block 235). For instance, the user device 105 may generate the request message and transmit the request message to the WIP service 115, as discussed above with respect to FIG. 1. In response to determining the user has not requested the report (block 230: No), the user device 105 may return to determine whether the user requests the report (block 230).

Generally, in response to receiving either the update product message or the update parts message, the WIP service 115 may update the WIP data 125A and/or the parts data 125B (block 225). The WIP service 115 may determine whether one or more of stages (A), (B), or (C) have occurred, or a default trigger condition is satisfied (block 240). In response to determining whether one or more of stages (A), (B), or (C) have not occurred, or the default trigger condition is not satisfied (block 240: No), the WIP service 115 may return to determine whether one or more of stages (A), (B), or (C) have occurred, or a default trigger condition is satisfied (block 240).

In response to determining whether one or more of stages (A), (B), or (C) have occurred, or a default trigger condition is satisfied (block 240: Yes), the WIP service 115 may proceed obtain the WIP data 125A and/or the parts data 125B (block 245). The WIP service 115 may proceed to analyze the WIP data 125A and/or the parts data 125B (block 250).

In stage (E), the WIP service 115 may proceed to transmit a report to the user device 105 (block 255). For instance, the WIP service 115 may generate and transmit a report based on the analysis process, as discussed above.

In stage (F), the WIP service 115 may proceed to transmit an instruction message to the workstation 120 (block 260). For instance, the WIP service 115 may generate and transmit the instruction message based on the analysis process, as discussed above.

In stage (G), the WIP service 115 may proceed to transmit a part request to the provider 130 (block 255). For instance, the WIP service 115 may generate and transmit the part request based on the analysis process, as discussed above.

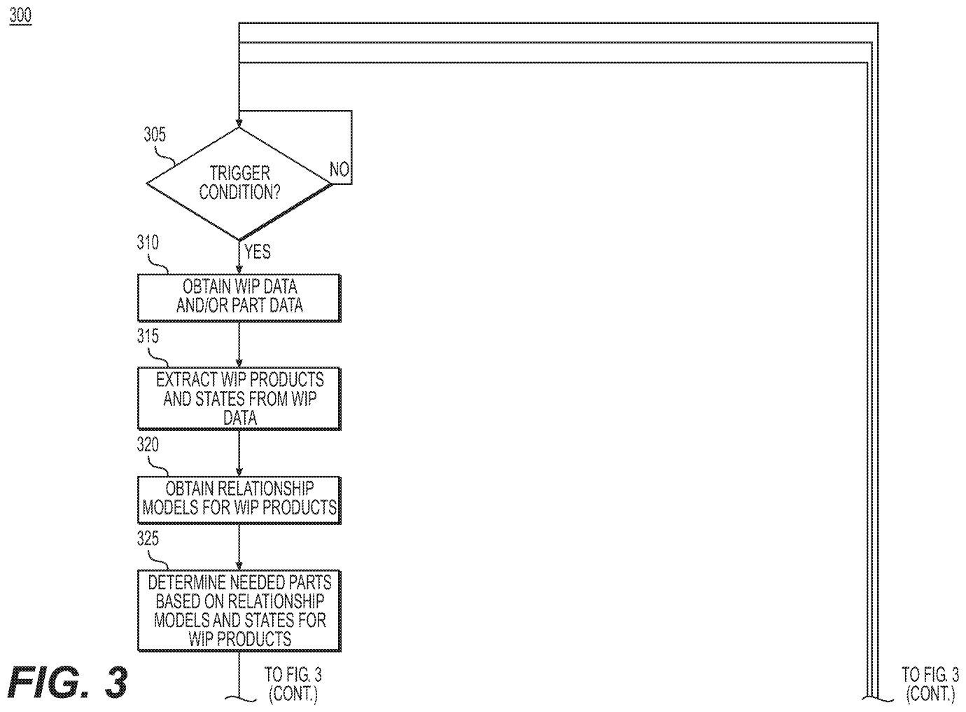

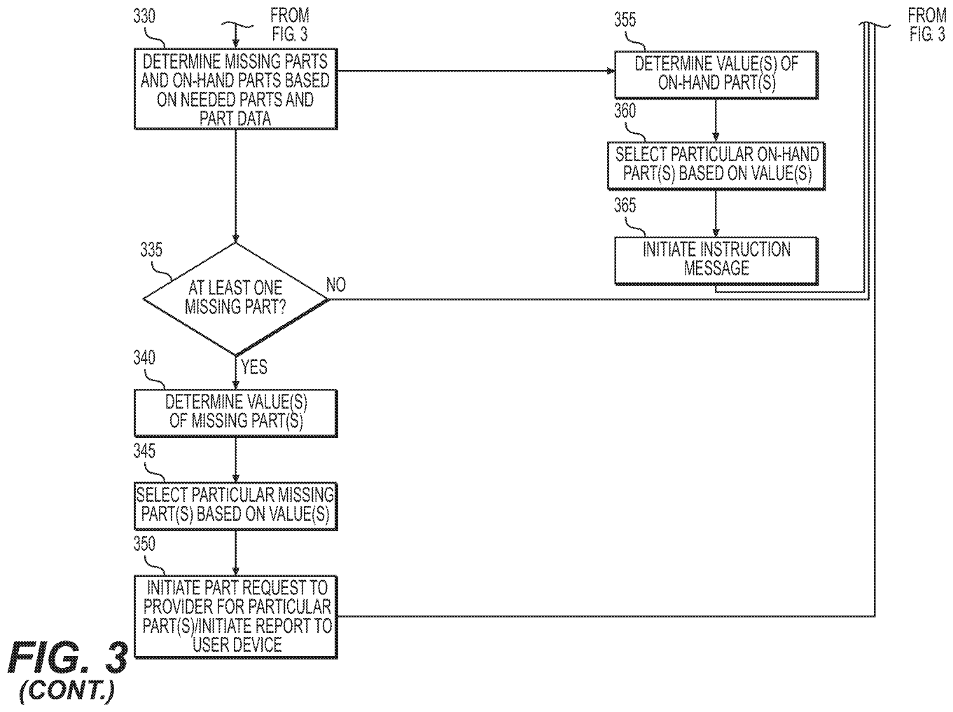

FIG. 3 depicts a flowchart 300 for identifying missing parts and stranded inventory, according to one or more embodiments. The flowchart 300 may depict the analysis process, discussed above. The analysis process of the flowchart 300 may be performed by the WIP service 115. The flowchart 300 of FIG. 3 may correspond to blocks 240-250 of FIG. 2 above.

The WIP service 115 may start the analysis process by determining whether one or more trigger conditions are satisfied (block 305). For instance, the trigger conditions may be whether one or more of stages (A), (B), or (C) have occurred, or the default trigger condition is satisfied, as discussed above. In response to determining the one or more trigger conditions are not satisfied d (block 305: No), the WIP service 115 may return to determine whether the one or more trigger conditions are satisfied (block 305). In response to determining whether the one or more trigger conditions are satisfied (block 305: Yes), the WIP service 115 may proceed obtain the WIP data 125A and/or the parts data 125B (block 310). For instance, the WIP service 115 may access the WIP information 125; and extract the WIP data 125A and/or the parts data 125B.

The WIP service 115 may proceed to extract WIP products and states from the WIP data 125A (block 315). For instance, the WIP service 115 may obtain the WIP products and states from the WIP data 125A, and associate states and WIP products based on the identifiers, as discussed above.

The WIP service 115 may proceed to obtain relationship models for the WIP products (block 320). For instance, the WIP service 115 may obtain the relationship models; select particular relationship models based on type identifiers of the WIP products, as discussed above.

The WIP service 115 may proceed to determine needed parts based on the relationship models and/or the states for WIP products (block 325). For instance, the WIP service 115 may determine the needed parts by determining the parts required to complete the WIP product, as discussed above.

The WIP service 115 may proceed to determine missing parts and/or on-hand parts based on needed parts and the parts data 125B (block 330). For instance, the WIP service 115 may determine missing parts by not finding matching part IDs in the parts data 125B and determine on-hand parts by finding matching part IDs in the parts data 125B, as discussed above.

In one aspect of the disclosure, the WIP service 115 may proceed to determine whether there is at least one missing part (block 335). In response to determining there is no missing part (block 335: No), the WIP service 115 may then proceed to return to determine whether the one or more trigger conditions are satisfied (block 305).

In response to determining there is at least one missing part (block 335: Yes), the WIP service 115 may proceed to determine value(s) of missing part(s) (block 340). For instance, the WIP service 115 may divide an expected value of a completed WIP product by a number of missing parts for the WIP product to determine a value for the corresponding missing parts of the WIP product, as discussed above.

The WIP service 115 may then proceed to select particular missing part(s) based on value(s) (block 345). For instance, the WIP service 115 may select a predetermined number of missing part(s) with a highest value, as discussed above.

The WIP service 115 may then proceed to initiate a part request to provider 130 for particular part(s) and/or initiate a report to user device 105 (block 350). The WIP service 115 may then proceed to return to determine whether the one or more trigger conditions are satisfied (block 305).

In one aspect of the disclosure, the WIP service 115 may proceed (e.g., from block 330) to determine value(s) of on-hand part(s) (block 355). For instance, the WIP service 115 may divide an expected value of a completed WIP product by a number of on-hand parts for the WIP product to determine a value for the corresponding on-hand parts of the WIP product, as discussed above.

The WIP service 115 may then proceed to select particular on-hand part(s) based on value(s) (block 360). For instance, the WIP service 115 may select a predetermined number of on-hand part(s) with a highest value, as discussed above.

The WIP service 115 may proceed to initiate an instruction message to the workstation 120 (block 365). The WIP service 115 may then proceed to return to determine whether the one or more trigger conditions are satisfied (block 305).

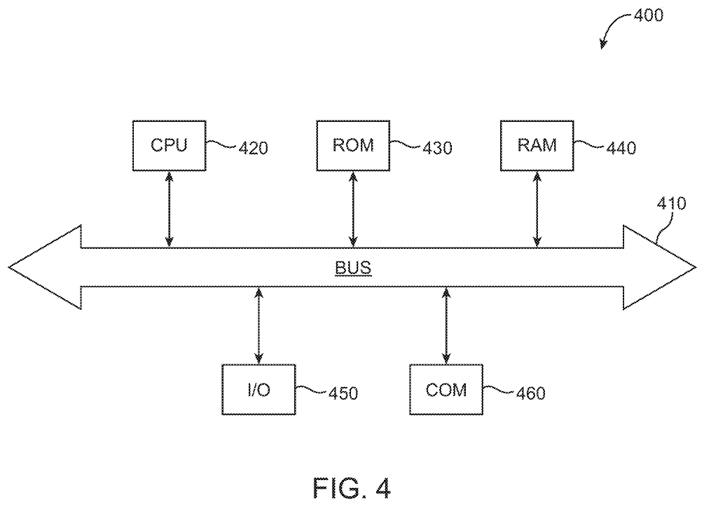

FIG. 4 depicts an example system that may execute techniques presented herein. FIG. 4 is a simplified functional block diagram of a computer that may be configured to execute techniques described herein, according to exemplary embodiments of the present disclosure. Specifically, the computer (or “platform” as it may not be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for identifying missing parts and stranded inventory, comprising:
obtaining parts data and work in progress (WIP) data associated with one or more production facilities, the parts data indicating one or more parts in an inventory to be used to produce one or more products, the WIP data indicating one or more WIP products currently in production;
analyzing the parts data and the WIP data to determine missing parts and/or on-hand parts for the one or more WIP products; and
performing at least one action for the missing parts and/or the on-hand parts.

2. The method of claim 1, further comprising, before the analyzing the parts data and the WIP data:
determining whether a trigger condition is satisfied; and
in response to determining the trigger condition is satisfied, analyzing the parts data and the WIP data to determine the missing parts and/or the on-hand parts for the one or more WIP products.

3. The method of claim 1, wherein the parts data includes:
a part ID for each part used in the one or more products produced in the one or more production facilities,
a count for each part ID that corresponds to a number of parts in the inventory for that part ID,
location information for each part in the inventory, and/or
expected cost for each part.

4. The method of claim 3, wherein the WIP data includes the one or more WIP products in the one or more production facilities and states for the one or more WIP products,
each of the one or more WIP products include an identifier, a type identifier, and an expected value of a completed WIP product, and
each of the states include an identifier for a corresponding WIP product and an indication of one or more parts already assembled for the WIP product.

5. The method of claim 4, wherein the analyzing the parts data and the WIP data includes:
extracting the one or more WIP products and the states for the one or more WIP products from the WIP data;
obtaining relationship models for the one or more WIP products;
determining needed parts based on the relationship models and/the states for the one or more WIP products; and
determining the missing parts and/or the on-hand parts based on the needed parts and the parts data.

6. The method of claim 5, wherein the determining the missing parts and/or the on-hand parts based on the needed parts and the parts data includes:
determining the missing parts by finding matching part IDs in the parts data that have a count equal to zero; and
determining the on-hand parts by finding matching part IDs in the parts data that have a count greater than zero.

7. The method of claim 1, wherein the performing the at least one action for the missing parts and/or the on-hand parts includes:
selecting particular missing parts and/or particular on-hand parts based on values of the missing parts and/or the on-hand parts;
generating a report based on the selected particular missing parts and/or particular on-hand parts; and
transmitting the report to a user device.

8. A system for identifying missing parts and stranded inventory, the system comprising:
a memory storing instructions; and
a processor executing the instructions to perform a process including:
obtaining parts data and work in progress (WIP) data associated with one or more production facilities, the parts data indicating one or more parts in an inventory to be used to produce one or more products, the WIP data indicating one or more WIP products currently in production;
analyzing the parts data and the WIP data to determine missing parts and/or on-hand parts for the one or more WIP products; and
performing at least one action for the missing parts and/or the on-hand parts.

9. The system of claim 8, wherein the process, before the analyzing the parts data and the WIP data, further includes:
determining whether a trigger condition is satisfied; and
in response to determining the trigger condition is satisfied, analyzing the parts data and the WIP data to determine the missing parts and/or the on-hand parts for the one or more WIP products.

10. The system of claim 8, wherein the parts data includes:
a part ID for each part used in the one or more products produced in the one or more production facilities,
a count for each part ID that corresponds to a number of parts in the inventory for that part ID,
location information for each part in the inventory, and/or
expected cost for each part.

11. The system of claim 10, wherein the WIP data includes the one or more WIP products in the one or more production facilities and states for the one or more WIP products,
each of the one or more WIP products include an identifier, a type identifier, and an expected value of a completed WIP product, and
each of the states include an identifier for a corresponding WIP product and an indication of one or more parts already assembled for the WIP product.

12. The system of claim 11, wherein the analyzing the parts data and the WIP data includes:
extracting the one or more WIP products and the states for the one or more WIP products from the WIP data;
obtaining relationship models for the one or more WIP products;
determining needed parts based on the relationship models and/the states for the one or more WIP products; and
determining the missing parts and/or the on-hand parts based on the needed parts and the parts data.

13. The system of claim 12, wherein the determining the missing parts and/or the on-hand parts based on the needed parts and the parts data includes:
determining the missing parts by finding matching part IDs in the parts data that have a count equal to zero; and
determining the on-hand parts by finding matching part IDs in the parts data that have a count greater than zero.

14. The system of claim 8, wherein the performing the at least one action for the missing parts and/or the on-hand parts includes:
selecting particular missing parts and/or particular on-hand parts based on values of the missing parts and/or the on-hand parts;
generating a report based on the selected particular missing parts and/or particular on-hand parts; and
transmitting the report to a user device.

15. A non-transitory computer-readable medium storing instructions that, when executed by a processor, cause the processor to perform a method for identifying missing parts and stranded inventory, the method comprising:
obtaining parts data and work in progress (WIP) data associated with one or more production facilities, the parts data indicating one or more parts in an inventory to be used to produce one or more products, the WIP data indicating one or more WIP products currently in production;
analyzing the parts data and the WIP data to determine missing parts and/or on-hand parts for the one or more WIP products; and
performing at least one action for the missing parts and/or the on-hand parts.

16. The non-transitory computer-readable medium of claim 15, further comprising, before the analyzing the parts data and the WIP data:
determining whether a trigger condition is satisfied; and
in response to determining the trigger condition is satisfied, analyzing the parts data and the WIP data to determine the missing parts and/or the on-hand parts for the one or more WIP products.

17. The non-transitory computer-readable medium of claim 15, wherein the parts data includes:
a part ID for each part used in the one or more products produced in the one or more production facilities,
a count for each part ID that corresponds to a number of parts in the inventory for that part ID,
location information for each part in the inventory, and/or
expected cost for each part.

18. The non-transitory computer-readable medium of claim 17, wherein the WIP data includes the one or more WIP products in the one or more production facilities and states for the one or more WIP products,
each of the one or more WIP products include an identifier, a type identifier, and an expected value of a completed WIP product, and
each of the states include an identifier for a corresponding WIP product and an indication of one or more parts already assembled for the WIP product.

19. The non-transitory computer-readable medium of claim 18, wherein the analyzing the parts data and the WIP data includes:
extracting the one or more WIP products and the states for the one or more WIP products from the WIP data;
obtaining relationship models for the one or more WIP products;
determining needed parts based on the relationship models and/the states for the one or more WIP products; and
determining the missing parts and/or the on-hand parts based on the needed parts and the parts data.

20. The non-transitory computer-readable medium of claim 15, wherein the performing the at least one action for the missing parts and/or the on-hand parts includes:
selecting particular missing parts and/or particular on-hand parts based on values of the missing parts and/or the on-hand parts;
generating a report based on the selected particular missing parts and/or particular on-hand parts; and
transmitting the report to a user device.
